(19) United States
(12) Patent Application Publication
(10) Pub. No.: US 2016/0241691 A1
(43) Pub. Date: Aug. 18, 2016

(54) PORTABLE DEVICE AND POSITION CONTROL METHOD

(71) Applicant: KYOCERA CORPORATION, Kyoto (JP)

(72) Inventor: Noritake SHIGA, Kyotanabe-shi (JP)

(21) Appl. No.: 15/139,172

(22) Filed: Apr. 26, 2016

Related U.S. Application Data
(63) Continuation of application No. PCT/JP2014/078469, filed on Oct. 27, 2014.

(30) Foreign Application Priority Data
Oct. 28, 2013 (JP) 2013-223675

(51) Int. Cl. H04M 1/18; H04M 1/02

(52) U.S. Cl. CPC H04M 1/185; H04M 1/0202

(57) ABSTRACT

A position change unit includes a movable unit and a drive unit configured to drive the movable unit so as to carry out reciprocating motion in a direction in parallel to a front surface of a housing. At least one processor is configured to control the drive unit. With reciprocating motion of the movable unit in which an acceleration in movement in one direction is higher than an acceleration in movement in the other direction, a moment rotating a portable device in a first direction of rotation is generated around an axis in parallel to the front surface of the housing and perpendicular to a direction of reciprocating motion.

### CROSS-REFERENCE TO RELATED APPLICATION

The present application is a continuation based on PCT Application No. PCT/JP2014/078469 filed on Oct. 27, 2014, which claims the benefit of Japanese Application No. 2013-223675 filed on Oct. 28, 2013. PCT Application No. PCT/JP2014/078469 is entitled “Portable Device And Posture Control Method”, and Japanese Application No. 2013-223675 is entitled “Portable Device and Position Control Method and Program”. The contents of which are incorporated by reference herein in their entirety.

### FIELD

The present disclosure relates to a portable device such as a portable telephone, a personal digital assistant (PDA), a tablet PC, an electronic book terminal, a portable music player, a portable television, and a portable navigation system. In addition, the present disclosure relates to a position control method which can be applied to such a portable device.

### BACKGROUND

A portable telephone having a display located on a front surface side of a housing has conventionally been known. In such a portable telephone, a substantially rectangular display slightly smaller in size than the housing is located, for example, on the front surface side of the housing having a substantially rectangular contour.

An object of the present disclosure is to suppress breakage of a portable device resulting from drop onto the ground.

### SUMMARY

A first embodiment relates to a portable device. The portable device according to the first embodiment includes a housing, a display located on a front surface side of the housing, and a position change unit located in the housing and configured to change a position of the portable device which is falling. The position change unit includes a movable unit and a drive unit configured to drive the movable unit so as to carry out reciprocating motion in a direction in parallel to a front surface of the housing. A portable telephone includes at least one processor configured to control the drive unit. With reciprocating motion of the movable unit in which an acceleration in movement in one direction is higher than an acceleration in movement in the other direction, a moment which rotates the portable device in a first direction of rotation is generated around an axis in parallel to the front surface of the housing and perpendicular to a direction of the reciprocating motion.

Effects and significance of the present disclosure will become more apparent from the following description of an embodiment shown below. An embodiment below, however, is merely by way of example and the present disclosure is not restricted to the description of an embodiment below.

### BRIEF DESCRIPTION OF THE DRAWINGS

FIG. 1A is a front view showing a configuration of a portable telephone according to an embodiment.

FIG. 1B is a rear view showing the configuration of the portable telephone according to an embodiment.

FIG. 1C is a right side view showing the configuration of the portable telephone according to an embodiment.

FIG. 2A is a front view showing a configuration of a vibrator according to an embodiment.

FIGS. 2B and 2C are diagrams showing reciprocating motion of a movable weight.

FIG. 3 is a block diagram showing an overall configuration of the portable telephone according to an embodiment.

FIGS. 4A and 4B are diagrams for illustrating control of drive of the vibrator for rotating the portable telephone according to an embodiment.

FIG. 5 is a flowchart showing position control processing according to an embodiment.

FIG. 6A is a diagram showing drop of the portable telephone when the portable telephone takes a position with a front surface of a cabinet facing upward at the time of start of drop, according to an embodiment.

FIG. 6B is a diagram showing drop of the portable telephone when the portable telephone takes a position with the front surface of the cabinet facing downward at the time of start of drop.

FIG. 7A is a flowchart showing position control processing according to a first modification.

FIG. 7B is a diagram showing drop of the portable telephone when a position of the portable telephone is controlled such that a side surface of the cabinet will hit the ground in the first modification.

FIG. 8A is a front view showing a configuration of the portable telephone according to a second modification.

FIG. 8B is a rear view showing the configuration of the portable telephone according to the second modification.

FIG. 8C is a right side view showing the configuration of the portable telephone according to the second modification.

FIG. 9A is a flowchart showing position control processing according to the second modification.

FIG. 9B is a diagram showing that a display is broken by a foreign matter on the ground when the portable telephone has fallen in a position with the front surface of the cabinet facing downward and extending horizontally, according to the second modification.

FIG. 9C is a diagram showing that direct hitting of the front surface of the cabinet against the foreign matter is avoided even though the foreign matter is present at a point of drop of the portable telephone.

FIG. 10A is a diagram showing that the vibrator is located in the cabinet such that the movable weight carries out reciprocating motion in an up-down direction of the cabinet, according to another modification.

FIG. 10B is a diagram showing locations of one vibrator and another vibrator according to another modification.

FIG. 11A is a front perspective view showing a configuration of a vibrator according to another modification.

FIG. 11B is a front view of a portable telephone 1 having a vibrator located.

FIG. 12A is a front perspective view showing a configuration of a vibrator according to another modification.

FIG. 12B is a side perspective view showing a configuration of the vibrator according to another modification.

FIG. 12C is a front view of a portable telephone having a vibrator located.

FIG. 13A is a diagram showing rotation of the movable weight according to another modification.

FIG. 13B is a diagram showing reciprocating motion of the movable weight.

### DETAILED DESCRIPTION

An embodiment will be described below with reference to the drawings.

In general, a portable telephone suffers from the following problems. A user may inadvertently drop on the ground, a portable telephone which he/she has been holding in his/her hand. The portable telephone structurally has a portion resistant to shock and a portion not resistant to shock. For example, a front surface of a housing where a display is located is not resistant to shock. When the front surface of the housing collides against the ground, the display tends to be broken. Upper, lower, left, and right side surfaces or corner portions of the housing are relatively resistant to shock, and when such a site collides against the ground, the portable telephone is relatively less likely to be broken.

An object of an embodiment below is to suppress breakage of a portable device resulting from such drop onto the ground.

<Configuration of Portable Telephone>

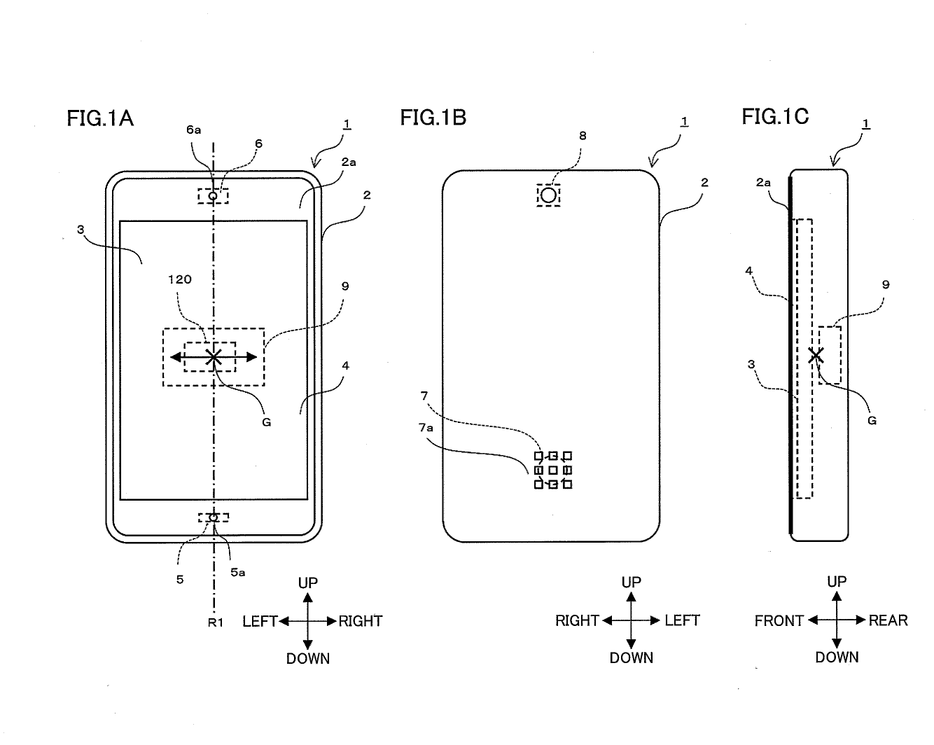

FIGS. 1A, 1B, and 1C are a front view, a rear view, and a right side view showing a configuration of a portable telephone 1, respectively. For the sake of convenience of description, as shown in FIGS. 1A to 1C, a longitudinal direction of a cabinet 2 is defined as an up-down direction and a direction of a short side of cabinet 2 is defined as a left-right direction. A direction perpendicular to the up-down direction and the left-right direction is defined as a front-rear direction.

As shown in FIGS. 1A to 1C, portable telephone 1 includes cabinet 2, a display 3, a touch panel 4, a microphone 5, an ear speaker 6, an external speaker 7, a camera 8, and a vibrator 9.

Cabinet 2 can be formed of a resin material and can have a substantially rectangular contour when viewed from the front. Display 3 can be located on a front surface side of cabinet 2. Display 3 can display various images (screens). Display 3 is implemented, for example, by a liquid crystal display. Display 3 may be implemented by other types of display such as an organic EL display. Touch panel 4 can be located to cover display 3. Touch panel 4 can be formed like a transparent sheet. Various types of touch panel such as a capacitance type, an ultrasonic type, a pressure sensitive type, a resistance film type, and an optical sensing type can be employed as touch panel 4. The front surface of cabinet 2 can be covered with a transparent cover 2a composed of glass.

In cabinet 2, microphone 5 can be located at a lower end portion. In cabinet 2, ear speaker 6 can be located at an upper end portion. Microphone 5 can accept voice and sound which has passed through a microphone hole 5a formed in a front surface of cabinet 2. Microphone 5 can generate an electric signal in accordance with input sound. Ear speaker 6 can output sound. Output sound can be emitted out of cabinet 2 through an output hole 6a formed in the front surface of cabinet 2. During a telephone call, voice and sound received from a device of a communication counterpart (such as a portable telephone) can be output from ear speaker 6 and voice uttered by a user can be input to microphone 5. Sound includes various types of sound such as voice and notification sound.

In cabinet 2, external speaker 7 can be located. In a rear surface of cabinet 2, an output hole 7a can be formed in a region facing external speaker 7. Sound output from external speaker 7 can be emitted out of cabinet 2 through output hole 7a.

In an upper portion of cabinet 2, camera 8 can be located on a rear surface side. Camera 8 includes an image pick-up element such as a CCD or a CMOS sensor and can shoot a subject.

In cabinet 2, vibrator 9 can be located. Vibrator 9 can be located at a position in the vicinity of a center of gravity G of portable telephone 1. As shown in FIGS. 1A and 1B, vibrator 9 can be located at a position substantially the same as center of gravity G of portable telephone 1, in the up-down direction and the left-right direction of cabinet 2. As shown in FIG. 1C, vibrator 9 can be located at a position slightly in the rear of center of gravity G of portable telephone 1 in the front-rear direction of cabinet 2.

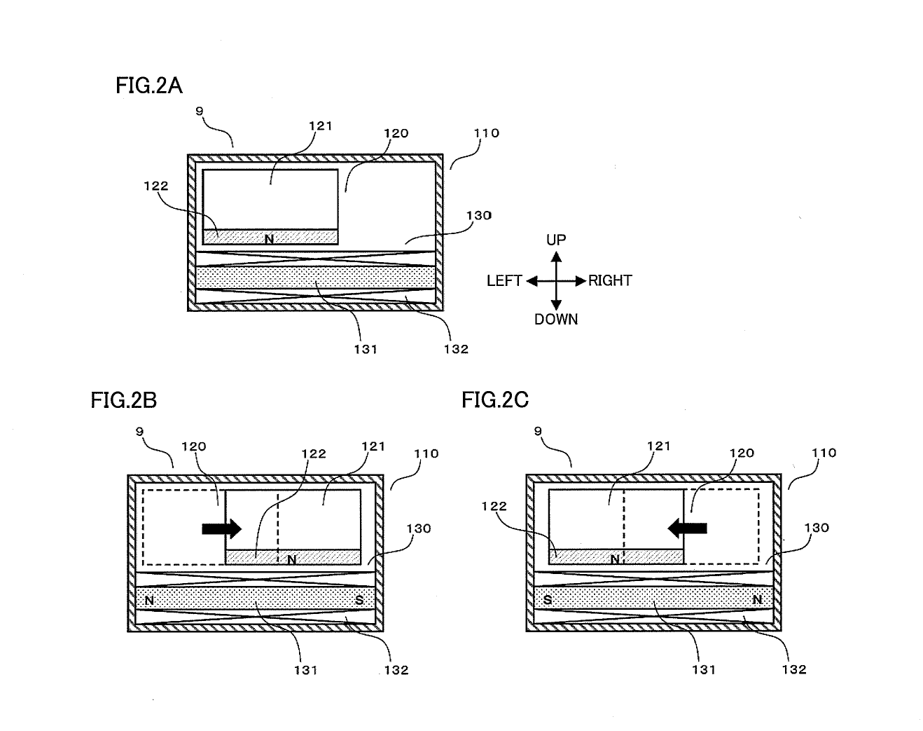

FIGS. 2A to 2C are diagrams for illustrating vibrator 9. FIG. 2A is a front perspective view showing a configuration of vibrator 9. FIGS. 2B and 2C are diagrams showing reciprocating motion of a movable weight 120.

Vibrator 9 can be what is called a linear vibrator (a linear oscillatory actuator). Vibrator 9 includes a case 110, movable weight 120, and a drive element 130. Case 110 can accommodate movable weight 120 and drive element 130.

Movable weight 120 includes a weight main body 121 made of a material relatively great in specific gravity, such as iron or lead, and a magnet 122 attached to weight main body 121. Magnet 122 has an N-magnetized region facing drive element 130. Movable weight 120 can be held to be movable in the left-right direction by means of a guide (not shown) located in case 110.

Drive element 130 can be located in case 110 such that a longitudinal direction thereof extends in the left-right direction. Drive element 130 can include a yoke 131 in a rod shape and a coil 132 wound around yoke 131.

As shown in FIG. 2A, when a current is fed to coil 132 such that the N pole is formed at the left end of drive element 130 and the S pole is formed at the right end thereof as shown in FIG. 2B while movable weight 120 is located at a left end in case 110, movable weight 120 can move to the right and reach the right end in case 110 owing to repulsive force generated on the N pole side and attractive force generated on the S pole side. When a current is fed to coil 132 such that the S pole is formed at the left end of drive element 130 and the N pole is formed at the right end as shown in FIG. 2C after movable weight 120 is located at the right end in case 110, movable weight 120 can move to the left and reach the left end in case 110 owing to repulsive force generated on the N pole side and attractive force generated on the S pole side. As a direction of a current fed to coil 132 is periodically switched, movable weight 120 can carry out reciprocating motion in the left-right direction. As a current fed to coil 132 is higher, repulsive force and attractive force applied by drive element 130 are stronger and hence an acceleration in movement of movable weight 120 can be higher.

As shown in FIG. 1A, vibrator 9 can be located in cabinet 2 such that movable weight 120 carries out reciprocating motion in the left-right direction of cabinet 2 (portable telephone 1).

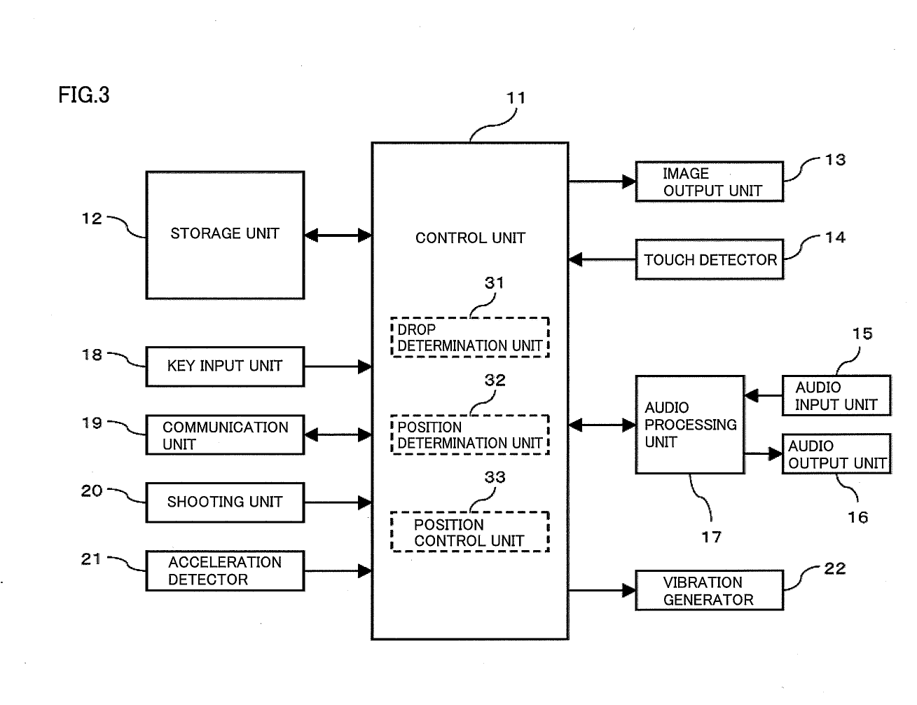

FIG. 3 is a block diagram showing an overall configuration of portable telephone 1.

As shown in FIG. 3, portable telephone 1 includes a control unit 11, a storage unit 12, an image output unit 13, a touch detector 14, an audio input unit 15, an audio output unit 16, an audio processing unit 17, a key input unit 18, a communication unit 19, a shooting unit 20, an acceleration detector 21, and a vibration generator 22.

Storage unit 12 includes a ROM, a RAM, and an external memory. Storage unit 12 stores various programs. A program stored in storage unit 12 includes not only a control program for controlling each unit of portable telephone 1 but also various application programs (hereinafter simply referred to as an “application”) such as applications for telephone calls, messages, a web browser, maps, games, and schedule management. The program stored in storage unit 12 further includes a program for performing position control processing which will be described later. The program is stored in storage unit 12 at the time of manufacturing of portable telephone 1 by a manufacturer and stored in storage unit 12 through a communication network or through a storage medium such as a memory card or a CD-ROM.

Storage unit 12 includes also a work area which stores data temporarily used or generated during execution of a program.

Control unit 11 includes a central processing unit (CPU). Control unit 11 can control each unit (storage unit 12, image output unit 13, touch detector 14, audio input unit 15, audio output unit 16, audio processing unit 17, key input unit 18, communication unit 19, shooting unit 20, acceleration detector 21, and vibration generator 22) implementing portable telephone 1, in accordance with a program stored in storage unit 12.

Image output unit 13 includes display 3 shown in FIG. 1A. Image output unit 13 can display an image (a screen) on display 3 based on a control signal and an image signal from control unit 11. Image output unit 13 can have display 3 turned on and off and have brightness of display 3 adjusted in response to a control signal from control unit 11.

Touch detector 14 includes touch panel 4 shown in FIG. 1A and can detect a touch operation onto touch panel 4. More specifically, touch detector 14 can detect a position of contact (hereinafter referred to as a “touch position”) onto touch panel 4 by a contact object such as a user's finger. Touch detector 14 can output a position signal generated based on a detected touch position to control unit 11. A touch operation onto touch panel 4 is performed onto a screen or an object displayed on display 3 and can also be referred to as a touch operation onto display 3.

Touch detector 14 may be configured to detect as a touch position, a position to which a user's finger is proximate when the finger is proximate to touch panel 4. For example, when touch panel 4 of touch detector 14 is of a capacitance type, sensitivity thereof can be adjusted such that variation in capacitance exceeds a detection threshold value at the time when a finger is proximate to touch panel 4.

When the front surface of cabinet 2 is covered with cover 2a as in this embodiment, a finger does not come in direct contact with touch panel 4 but the finger is in indirect contact with touch panel 4 with cover 2a being interposed. Touch panel 4 can detect a touch position when a finger is in contact with cover 2a or is proximate to cover 2a.

With touch panel 4 being located, a user can perform various touch operations onto display 3 by touching touch panel 4 (cover 2a) with his/her finger or by bringing his/her finger in proximity to touch panel 4 (cover 2a). The touch operation includes, for example, a tap operation, a flick operation, and a slide operation. The tap operation refers to an operation to bring a user's finger in contact with or in proximity to touch panel 4 and thereafter move his/her finger away from touch panel 4 in a short period of time. The flick operation refers to an operation to bring a user's finger in contact with or in proximity to touch panel 4 and thereafter flip or sweep touch panel 4 with his/her finger in any direction. The slide operation refers to an operation to move a user's finger in any direction while a user keeps his/her finger in contact with or in proximity to touch panel 4.

For example, when touch detector 14 detects a touch position and then the touch position is no longer detected within a first predetermined period of time since detection of the touch position, control unit 11 can determine such a touch operation as the tap operation. When a touch position has moved by a first predetermined distance or more within a second predetermined period of time since detection of the touch position and the touch position is no longer detected, control unit 11 can determine such a touch operation as the flick operation. When a touch position has moved by a second predetermined distance or more after detection of the touch position, control unit 11 can determine such a touch operation as the slide operation.

Audio input unit 15 includes microphone 5. Audio input unit 15 can output an electric signal from microphone 5 to audio processing unit 17.

Audio output unit 16 includes ear speaker 6 and external speaker 7. Audio output unit 16 can receive input of an electric signal from audio processing unit 17. Audio output unit 16 can have ear speaker 6 or external speaker 7 output sound.

Audio processing unit 17 can subject an electric signal from audio input unit 15 to A/D conversion and can output a resultant digital audio signal to control unit 11. Audio processing unit 17 can subject a digital audio signal from control unit 11 to decoding processing and D/A conversion, and can output the resultant electric signal to audio output unit 16.

Key input unit 18 can include at least one hard key. For example, key input unit 18 can include a power key for turning on power of portable telephone 1. Key input unit 18 can output a signal corresponding to a pressed hard key to control unit 11.

Communication unit 19 includes a circuit for converting a signal for a telephone call or communication and an antenna which transmits and receives radio waves. Communication unit 19 can convert a signal for a telephone call or communication input from control unit 11 into a radio signal and transmit the resultant radio signal to a communication destination such as a base station or other communication devices through the antenna. Furthermore, communication unit 19 can convert a radio signal received through the antenna into a signal in a format which can be used by control unit 11 and output the resultant signal to control unit 11.

Shooting unit 20 includes camera 8 shown in FIG. 1B. Shooting unit 20 can perform various types of image processing on data of images shot by camera 8 and output resultant image data to control unit 11.

Acceleration detector 21 can include a three-axis acceleration sensor. The three-axis acceleration sensor can detect an acceleration generated in three directions of the front-rear direction, the up-down direction, and the left-right direction of portable telephone 1. Acceleration detector 21 can output an acceleration signal in accordance with an acceleration detected by the three-axis acceleration sensor to control unit 11. The three-axis acceleration sensor can be located in cabinet 2 such that an acceleration applied in the front direction (a direction of the front surface), the right direction, and the upward direction is expressed with a positive value and an acceleration applied in the rear direction (a direction of the rear surface), the left direction, and the downward direction is expressed with a negative value.

Vibration generator 22 can include vibrator 9 shown in FIG. 1A and a supply circuit supplying a current to drive element 130 of vibrator 9. The supply circuit can supply a current to drive element 130 in response to a control signal from control unit 11.

<Control of Position of Portable Telephone>

A user may inadvertently drop portable telephone 1 which he/she has been holding with his/her hand onto the ground. Portable telephone 1 structurally has a portion resistant to shock and a portion not resistant to shock. For example, the front surface of cabinet 2 having display 3 located is not resistant to shock. When the front surface of cabinet 2 collides against the ground, display 3 tends to be broken.

In portable telephone 1 in an embodiment, vibrator 9 can be used to control a position of portable telephone 1 while it falls, and position control processing for suppressing breakage of portable telephone 1 can be performed by control unit 11.

Control unit 11 can include a drop determination unit 31, a position determination unit 32, and a position control unit 33. Drop determination unit 31, position determination unit 32, and position control unit 33 are implemented as a function of a program executed by control unit 11.

Drop determination unit 31 can determine whether or not portable telephone 1 has fallen, based on an acceleration applied to portable telephone 1. A drop threshold value for determining drop is set in advance based on an acceleration actually applied at the time when portable telephone 1 falls, and stored in storage unit 12. Drop determination unit 31 can determine that portable telephone 1 has fallen when a value for an acceleration applied to portable telephone 1, that is, an absolute value of an acceleration vector which is a result of synthesis of acceleration vectors in three directions of the front-rear, left-right, and up-down directions detected by the three-axis acceleration sensor of acceleration detector 21, exceeds the drop threshold value.

Position determination unit 32 can determine a position of portable telephone 1 while it falls. An acceleration applied during drop is distributed in acceleration components in three directions of the front-rear, left-right, and up-down directions in accordance with a position of portable telephone 1 while it falls. Position determination unit 32 can determine a position of portable telephone 1 based on a ratio among accelerations in the front-rear, left-right, and up-down directions detected by the three-axis acceleration sensor while the portable telephone falls.

Position control unit 33 can control drive element 130 of vibrator 9 to rotate portable telephone 1 such that portable telephone 1 takes a prescribed position for suppressing breakage of display 3 while the portable telephone falls.

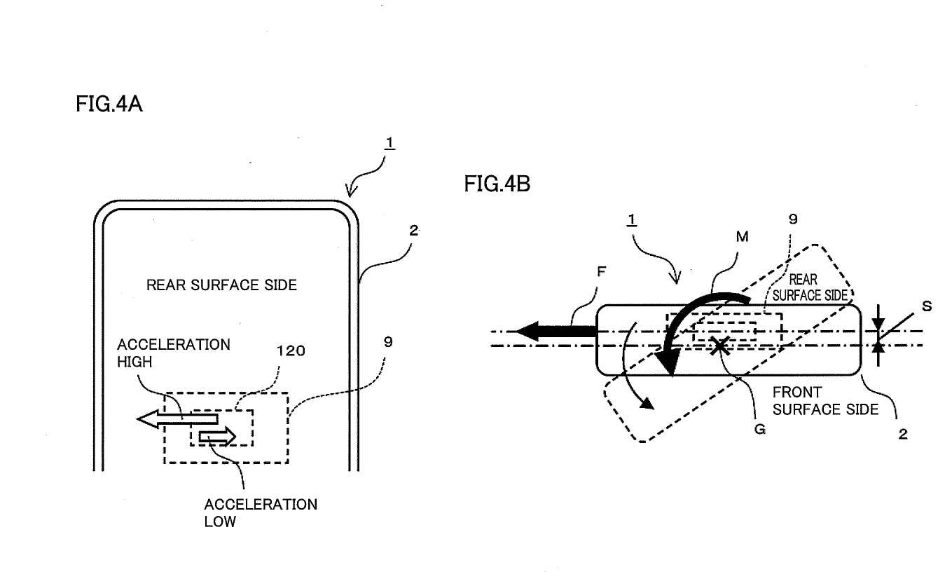

FIGS. 4A and 4B are diagrams for illustrating control for driving vibrator 9 for rotating portable telephone 1.

As shown in FIG. 4A, position control unit 33 can control drive element 130 such that an acceleration of movable weight 120 in movement in one direction is higher than an acceleration of movable weight 120 in movement in the other direction. When movable weight 120 carries out reciprocating motion high in acceleration in one direction and low in acceleration in the other direction, inertia force F in one direction is generated in portable telephone 1 as shown in FIG. 4B. Since vibrator 9 is located at a position displaced from center of gravity G in the front-rear direction of portable telephone 1, a deviation S is caused between a position where inertia force F is applied and the position of center of gravity G in the front-rear direction of portable telephone 1. A moment M (rotational force) around center of gravity G is thus generated in portable telephone 1. As moment M is applied, portable telephone 1 rotates around an axis of rotation R1 in the up-down direction which passes through center of gravity G shown in FIG. 1A. When position control unit 33 controls drive element 130 such that an acceleration of movable weight 120 in movement in the other direction is higher than an acceleration of movable weight 120 in movement in one direction, moment M in a direction reverse to the direction shown in FIG. 4B is generated and portable telephone 1 rotates in the reverse direction.

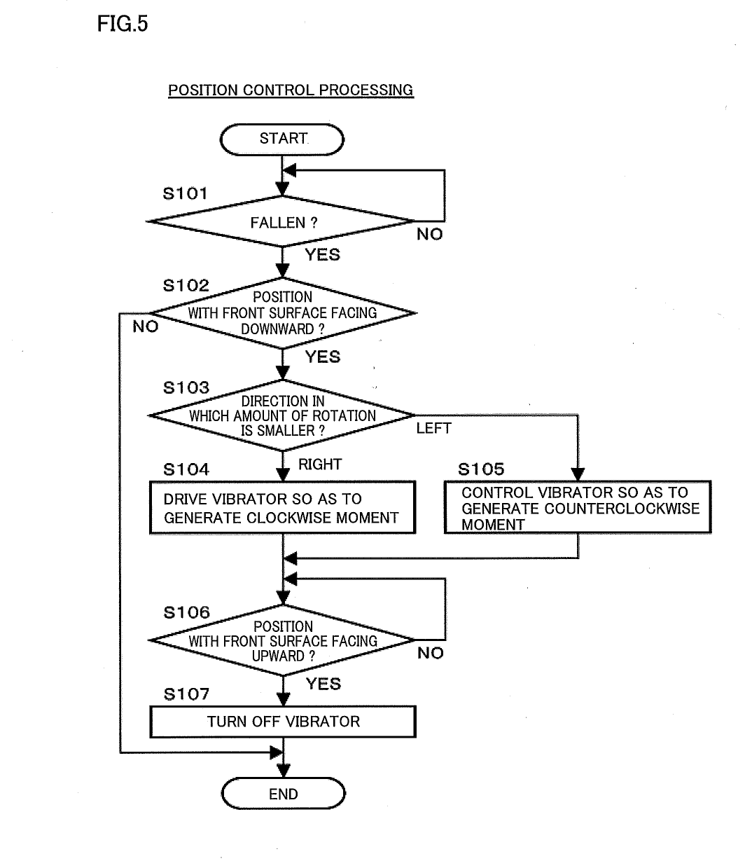

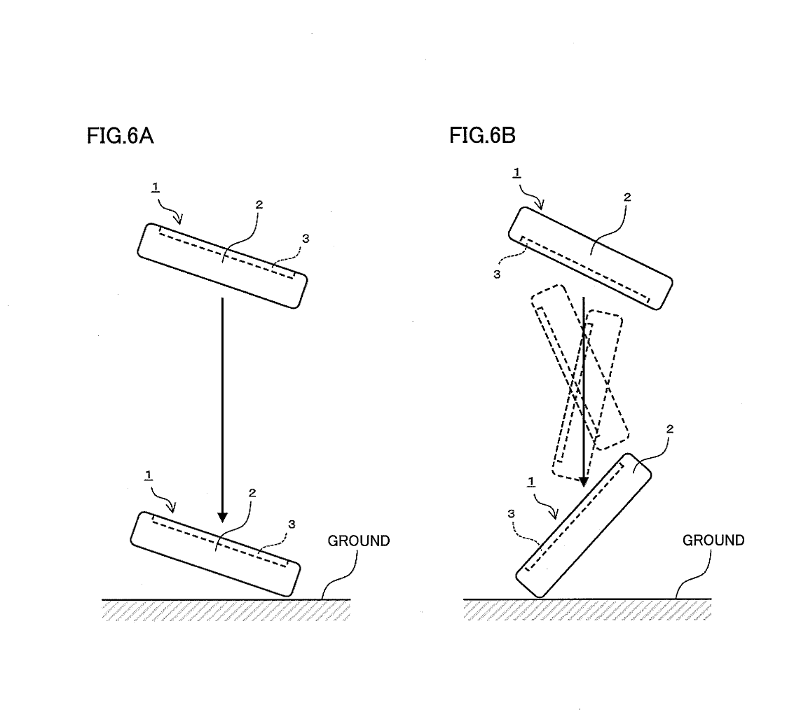

FIG. 5 is a flowchart showing position control processing. FIG. 6A is a diagram showing drop of portable telephone 1 when portable telephone 1 takes a position with the front surface of cabinet 2 facing upward at the time of start of drop. FIG. 6B is a diagram showing drop of portable telephone 1 when portable telephone 1 takes a position with the front surface of cabinet 2 facing downward at the time of start of drop.

Position control processing can repeatedly be performed while portable telephone 1 operates. In an embodiment, as a result of the position control processing in FIG. 5, when portable telephone 1 takes a position with the front surface of cabinet 2 facing downward while it falls, portable telephone 1 can be rotated such that the position of portable telephone 1 is changed to a position with the front surface of cabinet 2 facing upward.

If a user inadvertently drops portable telephone 1, control unit 11 (drop determination unit 31) can determine that portable telephone 1 has fallen (S101: YES). Control unit 11 (position determination unit 32) can determine whether or not portable telephone 1 takes a position with the front surface of cabinet 2 facing downward (S102). When portable telephone 1 takes a position with the front surface of cabinet 2 facing downward, an acceleration in the front-rear direction detected by acceleration detector 21 exhibits a positive value. When portable telephone 1 takes a position with the front surface of cabinet 2 facing upward, an acceleration in the front-rear direction exhibits a negative value.

When the front surface of cabinet 2 faces downward, the front surface of cabinet 2 will hit the ground. Display 3, touch panel 4, and cover 2a located on the front surface side of cabinet 2 are not resistant to shock and are likely to break. When the front surface of cabinet 2 faces upward, the rear surface of cabinet 2 will hit the ground. Since cabinet 2 is formed of a resin material and there is no display 3 on the rear surface side, the rear surface itself or display 3 is less likely to break.

When portable telephone 1 takes a position with the front surface of cabinet 2 facing upward (S102: NO), control unit 11 can quit the position control processing. As shown in FIG. 6A, portable telephone 1 hits the ground from the rear surface side of cabinet 2 as it is without change in position. The position control processing which has once ended is immediately resumed.

When portable telephone 1 takes a position with the front surface of cabinet 2 facing downward (S102: YES), control unit 11 can determine to which of left and right an amount of rotation (an angle of rotation) of portable telephone 1 is smaller at the time when portable telephone 1 is changed in position such that the front surface of cabinet 2 faces upward (S103). For example, with portable telephone 1 taking a position inclined to the right as in FIG. 6B, an amount of rotation will be smaller when portable telephone 1 is rotated clockwise. With portable telephone 1 taking a position inclined to the left, an amount of rotation will be smaller when portable telephone 1 is rotated counterclockwise.

When a direction of rotation smaller in amount of rotation is right (S103: right), control unit 11 (position control unit 33) can drive vibrator 9 such that clockwise moment M is generated (S104). Thus, portable telephone 1 rotates clockwise around axis of rotation R1. When a direction of rotation smaller in amount of rotation is left (S103: left); control unit 11 (position control unit 33) can drive vibrator 9 such that counterclockwise moment M is generated (S105). Thus, portable telephone 1 rotates counterclockwise around axis of rotation R1. When an amount of rotation is the same between a clockwise direction and a counterclockwise direction, control unit 11 (position control unit 33) can drive vibrator 9 such that moment M in a predetermined direction of rotation (for example, clockwise) is generated.

Control unit 11 (position determination unit 32) can determine whether or not portable telephone 1 is in a position with the front surface of cabinet 2 facing upward (S106). When portable telephone 1 is in the position with the front surface of cabinet 2 facing upward (S106: YES), control unit 11 (position control unit 33) can turn off vibrator 9 (S107). The position control processing once ends and can subsequently be resumed.

As shown in FIG. 6B, when portable telephone 1 takes a position with the front surface of cabinet 2 facing downward at the time of start of drop, portable telephone 1 can rotate and can change the position such that the front surface of cabinet 2 faces upward. Portable telephone 1 will hit the ground from the rear surface side of cabinet 2.

In consideration of strength of display 3, touch panel 4, and cover 2a, a lower limit height (for example, 1 m) from the ground at which portable telephone 1 may be broken when it falls on the ground is grasped through experiments. Portable telephone 1 requires such a speed of rotation as allowing rotation of portable telephone 1 to a position with the front surface of cabinet 2 facing upward within a time period of drop until portable telephone 1 hits the ground from the lower limit height under a condition requiring the greatest amount of rotation. Performance of vibrator 9 such as a weight and a movable stroke of movable weight 120 and driving force of drive element 130 is determined such that moment M allowing obtainment of such a speed of rotation is generated.

Portable telephone 1 in an embodiment has a normal mode in which a user is notified of incoming of a telephone call or a mail by notification sound and a manner mode in which a user is notified of an incoming call by vibration. When an incoming call is received while the manner mode has been set, control unit 11 can drive drive element 130 so as to vibrate vibrator 9 such that movable weight 120 carries out reciprocating motion at the same acceleration in both of movement in one direction (a right direction) and movement in the other direction (a left direction).

<Function and Effect>

According to an embodiment above, a position of portable telephone 1 can be changed such that a position allowing suppression of breakage of display 3, specifically, a position with the front surface of cabinet 2 facing upward, is taken while portable telephone 1 falls. Breakage of portable telephone 1 resulting from drop onto the ground can be suppressed.

Furthermore, according to an embodiment, portable telephone 1 can rotate in a direction of rotation in which an amount of rotation for change to a position with the front surface of cabinet 2 facing upward is smaller. A speed of rotation required for completion of change in position during drop can thus be suppressed and required performance of vibrator 9 can be suppressed.

In addition, according to an embodiment, vibrator 9 can also function as notification means for notification by vibration.

Though an embodiment has been described above, the present disclosure is not restricted by such an embodiment and an embodiment is also susceptible to various modifications other than the above.

<First Modification>

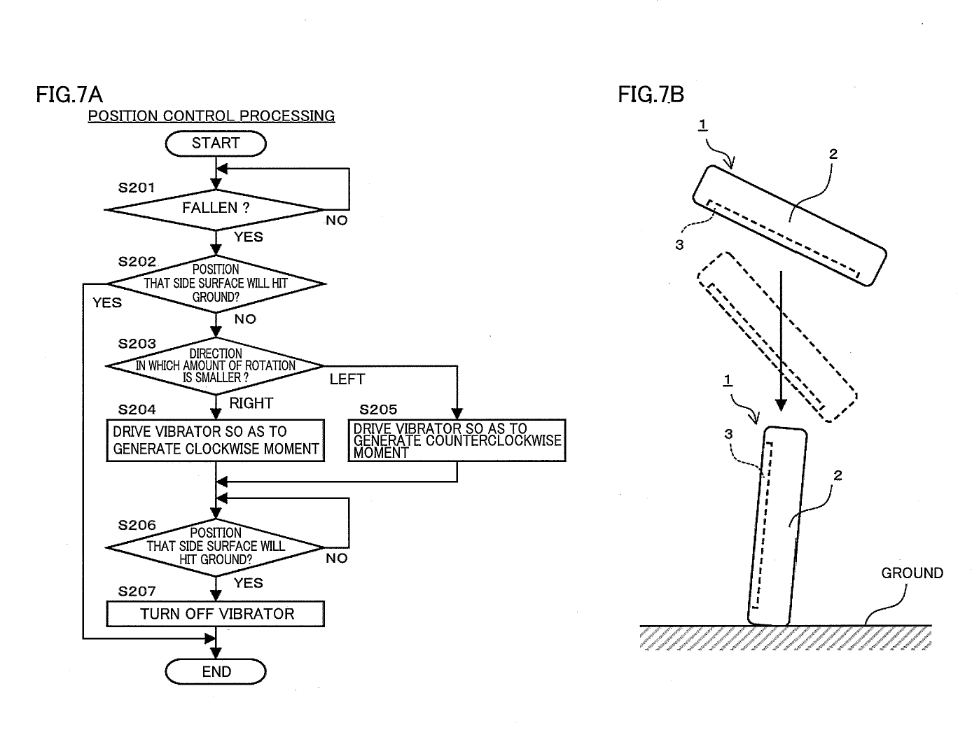

FIGS. 7A and 7B are diagrams for illustrating control of a position of portable telephone 1 while it falls according to a first modification. FIG. 7A is a flowchart showing position control processing. FIG. 7B is a diagram showing drop of portable telephone 1 when a position of portable telephone 1 is controlled such that a side surface of cabinet 2 will hit the ground.

The upper, lower, left, and right side surfaces of portable telephone 1 are normally higher in strength than the front surface and the rear surface of cabinet 2. In the present modification, while portable telephone 1 falls, portable telephone 1 can be rotated such that a position thereof is changed to such a position that a side surface of cabinet 2 will hit the ground, as a result of position control processing in FIG. 7A.

Referring to FIG. 7A, when portable telephone 1 falls (S201: YES), control unit 11 (position determination unit 32) can determine whether or not portable telephone 1 takes such a position that any of upper, lower, left, and right side surfaces of cabinet 2 will hit the ground (S202). When any side surface of cabinet 2 is in a horizontal state in the left-right direction or when an inclination of any side surface from the horizontal state is within a small angle (for example, an angle approximately from 5° to 10°), position determination unit 32 can determine that portable telephone 1 takes such a position that any side surface of cabinet 2 will hit the ground. When a side surface of cabinet 2 is in the horizontal state or an inclination of any side surface from the horizontal state is within a small angle, an acceleration in the front-rear direction detected by acceleration detector 21 exhibits zero or a value close to zero.

When portable telephone 1 does not take such a position that any side surface of cabinet 2 will hit the ground (S202: NO), control unit 11 can determine to which of left and right an amount of rotation of portable telephone 1 is smaller when a position of portable telephone 1 is changed such that a side surface thereof will hit the ground (S203).

When a direction of rotation smaller in amount of rotation is right (S203: right), control unit 11 (position control unit 33) can drive vibrator 9 such that clockwise moment M is generated (S204). Thus, portable telephone 1 can rotate clockwise around axis of rotation R1. When a direction of rotation smaller in amount of rotation is left (S203: left), control unit 11 (position control unit 33) can drive vibrator 9 such that counterclockwise moment M is generated (S205). Thus, portable telephone 1 can rotate counterclockwise around axis of rotation R1.

Control unit 11 (position determination unit 32) can determine whether or not portable telephone 1 has taken such a position that any side surface of cabinet 2 will hit the ground (S206). When portable telephone 1 takes such a position that any side surface of cabinet 2 will hit the ground (S206: YES), control unit 11 (position control unit 33) can turn off vibrator 9 (S207).

As shown in FIG. 7B, when portable telephone 1 does not take such a position that a side surface of cabinet 2 will hit the ground at the time of start of drop, portable telephone 1 is rotated while it falls and a position of portable telephone 1 is changed such that the portable telephone takes such a position that a side surface of cabinet 2 will hit the ground. Portable telephone 1 hits the ground from a side surface of cabinet 2.

When a side surface of cabinet 2 is in the horizontal state in the left-right direction and when cabinet 2 is in the horizontal state also in the up-down direction, the entire side surface will hit the ground. When cabinet 2 is inclined in the up-down direction, however, a part of a side surface rather than the entire side surface will hit the ground. Such a position that a part of a side surface of cabinet 2 will hit the ground is also included in a position that a side surface of cabinet 2 will hit the ground.

Portable telephone 1 requires such a speed of rotation as allowing rotation of portable telephone 1 to such a position that a side surface of cabinet 2 will hit the ground within a time period of drop until portable telephone 1 falls onto the ground from the lower limit height under a condition requiring the greatest amount of rotation. Performance of vibrator 9 such as a weight and a movable stroke of movable weight 120 and driving force of drive element 130 is determined such that moment M allowing obtainment of such a speed of rotation is generated.

According to the configuration in the first modification, a function and effect the same as in an embodiment above can be achieved.

<Second Modification>

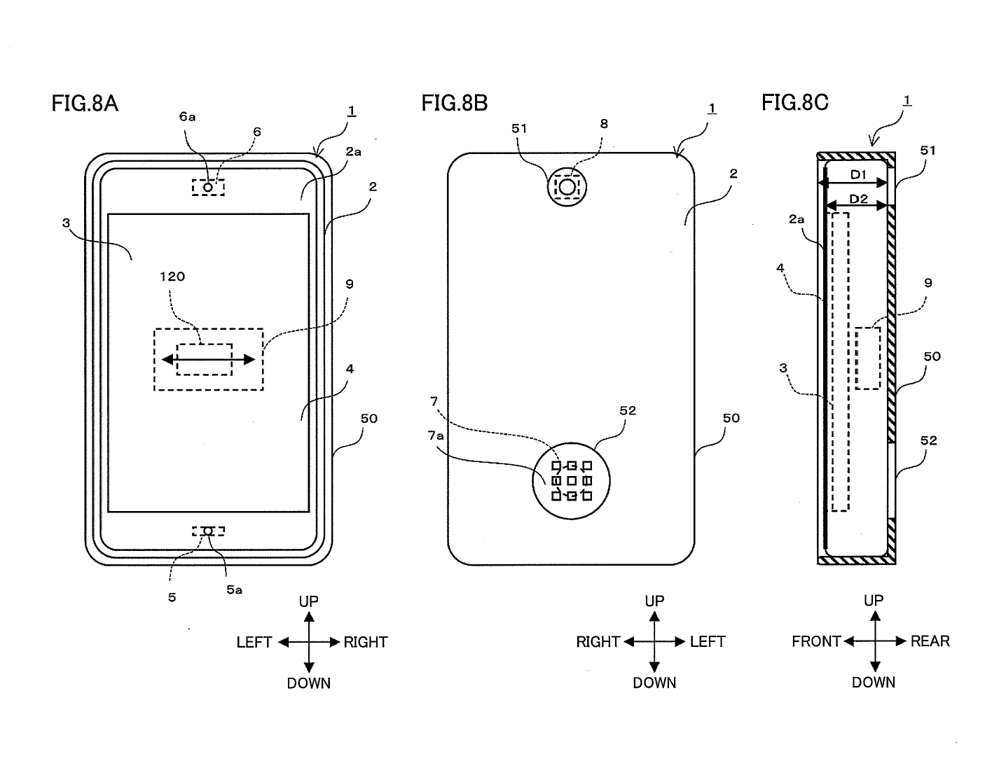

FIGS. 8A, 8B, and 8C are a front view, a rear view, and a right side view showing a configuration of portable telephone 1 according to a second modification, respectively.

Portable telephone 1 according to the second modification includes a protection case 50 accommodating cabinet 2. Protection case 50 covers the rear surface and the upper, lower, left, and right side surfaces of portable telephone 1 by accommodating portable telephone 1 in an accommodation portion 50a. Protection case 50 is formed of an elastic material such as rubber or a reinforced resin material such as FRP. A depth dimension D1 of accommodation portion 50a of protection case 50 is greater than a dimension D2 from the front to the rear of cabinet 2, and a front edge of protection case 50a protrudes forward from the front surface of cabinet 2 while cabinet 2 is accommodated in protection case 50. In the rear surface of protection case 50, a first opening portion 51 and a second opening portion 52 can be formed at a position facing camera 8 and a position facing external speaker 7, respectively.

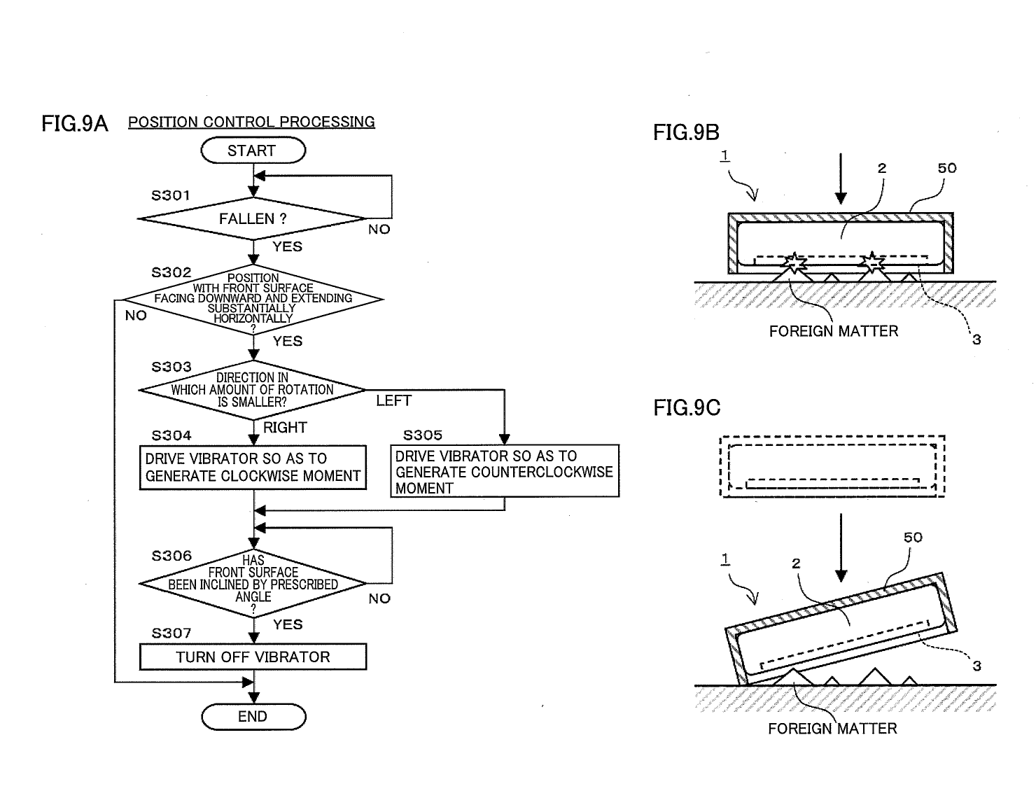

FIGS. 9A to 9C are diagrams for illustrating control of a position of portable telephone 1 while it falls according to the second modification. FIG. 9A is a flowchart showing position control processing. FIG. 9B is a diagram showing that display 3 is broken by a foreign matter on the ground when portable telephone 1 has fallen in a position with the front surface of cabinet 2 facing downward and extending horizontally. FIG. 9B is a diagram showing that breakage of display 3 by the foreign matter on the ground is avoided by position control processing in FIG. 9A when portable telephone 1 falls in a position with the front surface of cabinet 2 facing downward and extending horizontally.

In portable telephone 1 in the second modification, since the rear surface and the upper, lower, left, and right side surfaces are protected by protection case 50, breakage of portable telephone 1 is prevented even though portable telephone 1 falls and hits the ground from such a surface. Even though portable telephone 1 falls on the ground with the front surface of cabinet 2 facing downward and extending horizontally, the front edge of protection case 50 normally hits the ground before the front surface of cabinet 2, and hence breakage of display 3 is prevented. When a hard foreign matter is present on the ground as in FIG. 9B, however, the front surface of cabinet 2 may hit the foreign matter and display 3 may be broken before the front edge of protection case 50 hits the ground.

In the second modification, when portable telephone 1 takes a position with the front surface of cabinet 2 facing downward and extending horizontally (in the horizontal state and in a state close to horizontal) while it falls, portable telephone 1 can be rotated such that it takes a position deviating from that position, that is, a position with the front surface of cabinet 2 being inclined with respect to a horizontal plane by a prescribed angle, as a result of position control processing in FIG. 9A.

Referring to FIG. 9A, when portable telephone 1 falls (S301: YES), control unit 11 (position determination unit 32) can determine whether or not portable telephone 1 takes a position with the front surface of cabinet 2 facing downward and extending substantially horizontally (S302). In the second modification, determination as to whether or not the front surface of cabinet 2 extends substantially horizontally can be made by determining whether or not the front surface of cabinet 2 is inclined with respect to the horizontal plane by a prescribed angle (for example, 10°) or smaller in the left-right direction and the up-down direction.

When portable telephone 1 takes a position with the front surface of cabinet 2 facing downward and extending substantially horizontally (S302: YES), control unit 11 can determine to which of left and right an amount of rotation of portable telephone 1 is smaller when a position is changed such that the front surface of cabinet 2 is inclined by a prescribed angle with respect to the horizontal plane (S303).

When a direction of rotation smaller in amount of rotation is right (S303: right), control unit 11 (position control unit 33) can drive vibrator 9 such that clockwise moment M is generated (S304). Thus, portable telephone 1 can rotate clockwise around axis of rotation R1. When a direction of rotation smaller in amount of rotation is left (S303: left), control unit 11 (position control unit 33) can drive vibrator 9 such that counterclockwise moment M is generated (S305). Thus, portable telephone 1 can rotate counterclockwise around axis of rotation R1.

Control unit 11 (position determination unit 32) can determine whether or not the front surface of cabinet 2 has been inclined with respect to the horizontal plane by a prescribed angle (for example, an angle approximately from 10° to 15°) in the left-right direction (S306).

When the front surface of cabinet 2 is inclined with respect to the horizontal plane by a prescribed angle in the left-right direction (S306: YES), control unit 11 (position control unit 33) can turn off vibrator 9 (S307).

Thus, in the second modification, when such a position is taken that front surface of cabinet 2 faces downward and extends substantially horizontally at the time of start of drop, portable telephone 1 rotates while it falls and the front surface of cabinet 2 is inclined with respect to the horizontal plane such that the front surface of cabinet 2 no longer extends substantially horizontally. Thus, as shown in FIG. 9C, even when a foreign matter is present at a point of drop of portable telephone 1, direct hitting of the front surface of cabinet 2 against the foreign matter can be avoided. According to the second modification, breakage of portable telephone 1 resulting from drop onto the ground can be suppressed.

Portable telephone 1 requires such a speed of rotation as allowing rotation of portable telephone 1 until the front surface of cabinet 2 is inclined by a prescribed angle with respect to the horizontal plane within a time period of drop until portable telephone 1 falls onto the ground from the lower limit height under a condition requiring the greatest amount of rotation. Performance of vibrator 9 such as a weight and a movable stroke of movable weight 120 and driving force of drive element 130 is determined such that moment M allowing obtainment of such a speed of rotation is generated. In the second modification, cabinet 2 should only be inclined to such an extent as allowing avoidance of a foreign matter, and an amount of rotation of portable telephone 1 while it falls can be small. Therefore, performance of vibrator 9 can be kept lower than in an embodiment above and the first modification.

<Other Modifications>

Though vibrator 9 is located in the vicinity of center of gravity G of portable telephone 1 in an embodiment above, the first modification, and the second modification, it may be located at other positions.

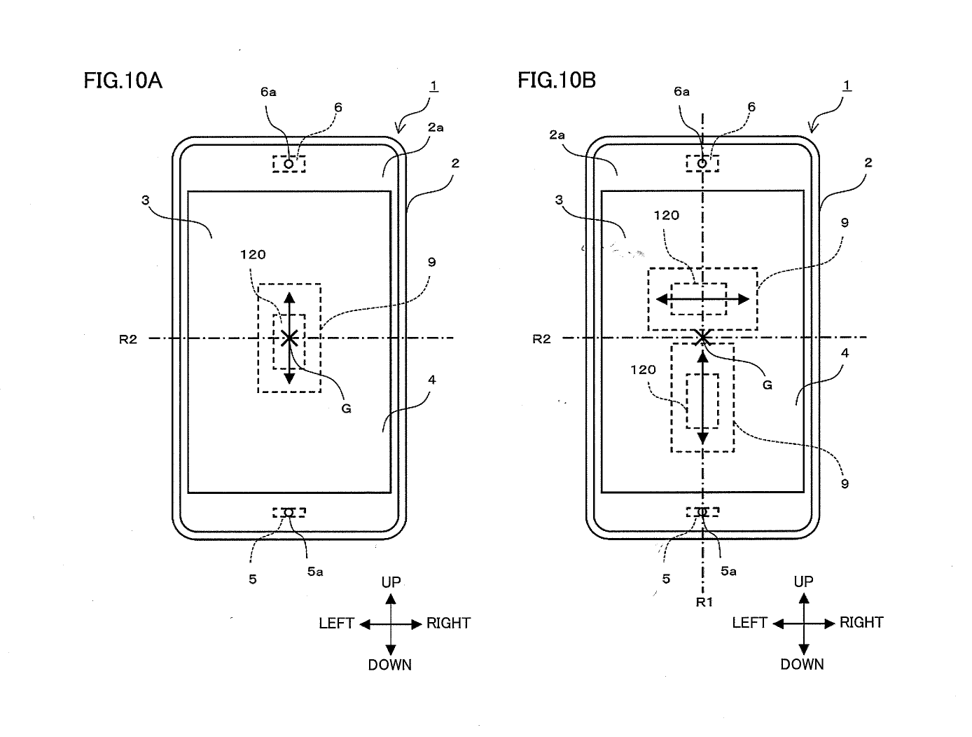

In an embodiment above, the first modification, and the second modification, vibrator 9 is located in cabinet 2 such that movable weight 120 carries out reciprocating motion in the left-right direction of cabinet 2. As shown in FIG. 10A, however, vibrator 9 may be located in cabinet 2 such that movable weight 120 carries out reciprocating motion in the up-down direction of cabinet 2. In this case, portable telephone 1 rotates around an axis of rotation R2 extending in the left-right direction which passes through center of gravity G.

In an embodiment above, the first modification, and the second modification, a single vibrator 9 is located in cabinet 2, however, a plurality of vibrators 9 may be located. For example, vibrators 9 may be located in the same orientations in respective corner portions of cabinet 2.

As shown in FIG. 10B, in cabinet 2, one vibrator 9 may be located such that movable weight 120 carries out reciprocating motion in the left-right direction of cabinet 2 and another vibrator 9 may be located such that movable weight 120 carries out reciprocating motion in the up-down direction of cabinet 2. As portable telephone 1 can thus be rotated in four directions of the up, down, left, and right directions, a position of portable telephone 1 can finely be controlled such that a more limited site such as a specific side surface or a specific corner portion will hit the ground. Movable weight 120 and drive element 130 of one vibrator 9 correspond to the first movable unit and the first drive unit, respectively, and movable weight 120 and drive element 130 of another vibrator 9 correspond to the second movable unit and the second drive unit, respectively.

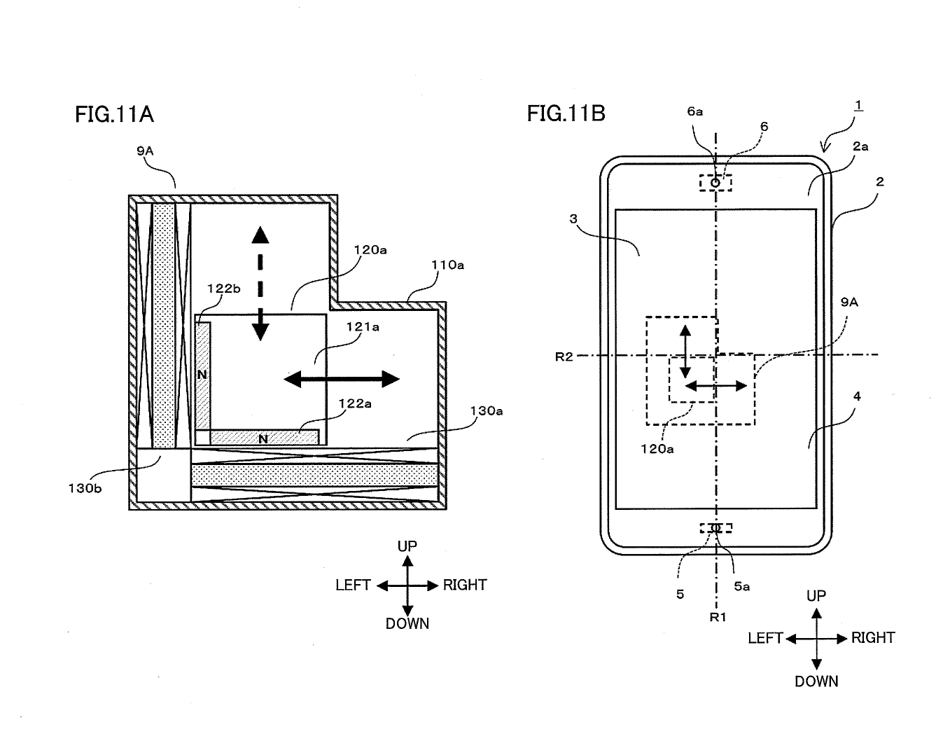

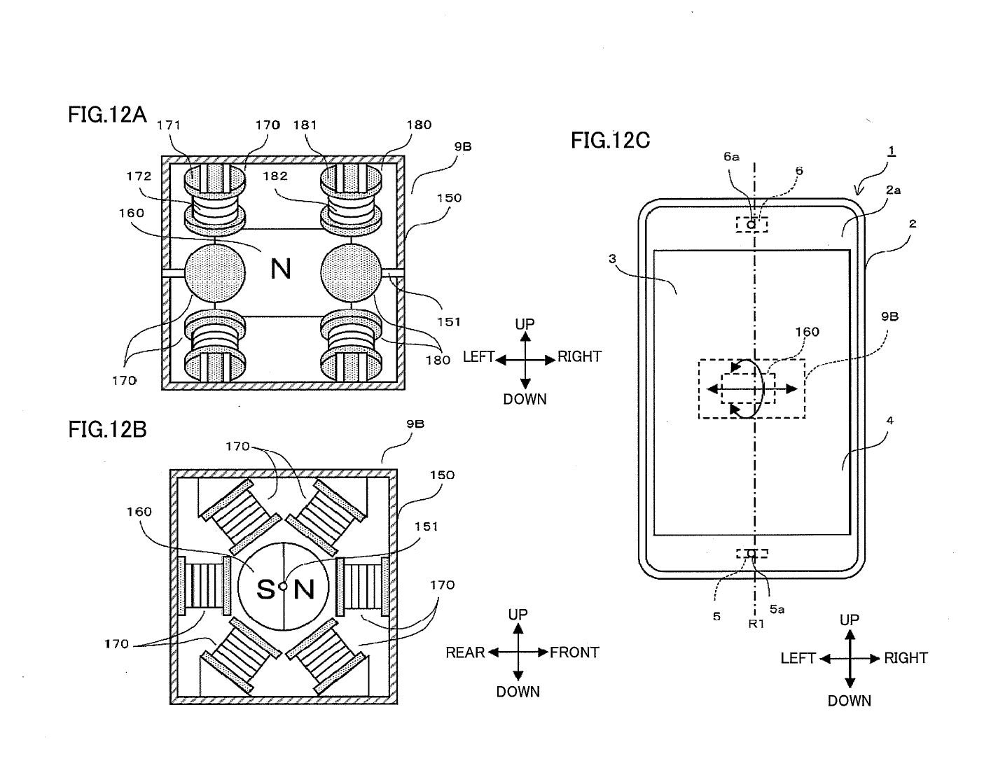

Instead of the two vibrators shown in FIG. 10B, a vibrator 9A shown in FIG. 11A or a vibrator 9B shown in FIGS. 12A and 12B may be employed.

FIG. 11A is a front perspective view showing a configuration of vibrator 9A. FIG. 11B is a front view of portable telephone 1 having vibrator 9A located. An instance including vibrator 9A will be described with reference to FIGS. 11A and 11B.

Vibrator 9A includes a case 110a, a movable weight 120a, a first drive element 130a, and a second drive element 130b. Case 110a accommodates movable weight 120a, first drive element 130a, and second drive element 130b.

Movable weight 120 includes a weight main body 121a made of a material relatively large in specific gravity, such as iron or lead, and a first magnet 122a and a second magnet 122b attached to weight main body 121a. First magnet 122a can have an N-magnetized region facing first drive element 130a and second magnet 122b can have an N-magnetized region facing second drive element 130b. Movable weight 120a is held to be movable in the left-right direction and the up-down direction by means of a guide (not shown) located in case 110a.

First drive element 130a can be located in case 110 such that the longitudinal direction thereof extends in the left-right direction. Second drive element 130b can be located in case 110 such that the longitudinal direction thereof extends in the up-down direction. First drive element 130a and second drive element 130b are the same in configuration as drive element 130 of vibrator 9.

When a current is fed to first drive element 130a such that polarities of respective end portions of first drive element 130a are alternately switched, movable weight 120a can carry out reciprocating motion in the left-right direction as shown with a solid arrow in FIG. 11A. When a current is fed to second drive element 130b such that polarities of respective end portions of second drive element 130b are alternately switched, movable weight 120a can carry out reciprocating motion in the up-down direction as shown with a dashed arrow in FIG. 11A.

As shown in FIG. 11B, vibrator 9A can be located in the vicinity of center of gravity G in cabinet 2 such that movable weight 120a carries out reciprocating motion in the left-right direction and in the up-down direction of cabinet 2. Portable telephone 1 can rotate in the left-right direction around axis of rotation R1, with moment M generated by reciprocating motion of movable weight 120a in the left-right direction, which has a difference in acceleration. Furthermore, portable telephone 1 can rotate in the up-down direction around axis of rotation R2, with moment M generated by reciprocating motion of movable weight 120a in the up-down direction, which has a difference in acceleration.

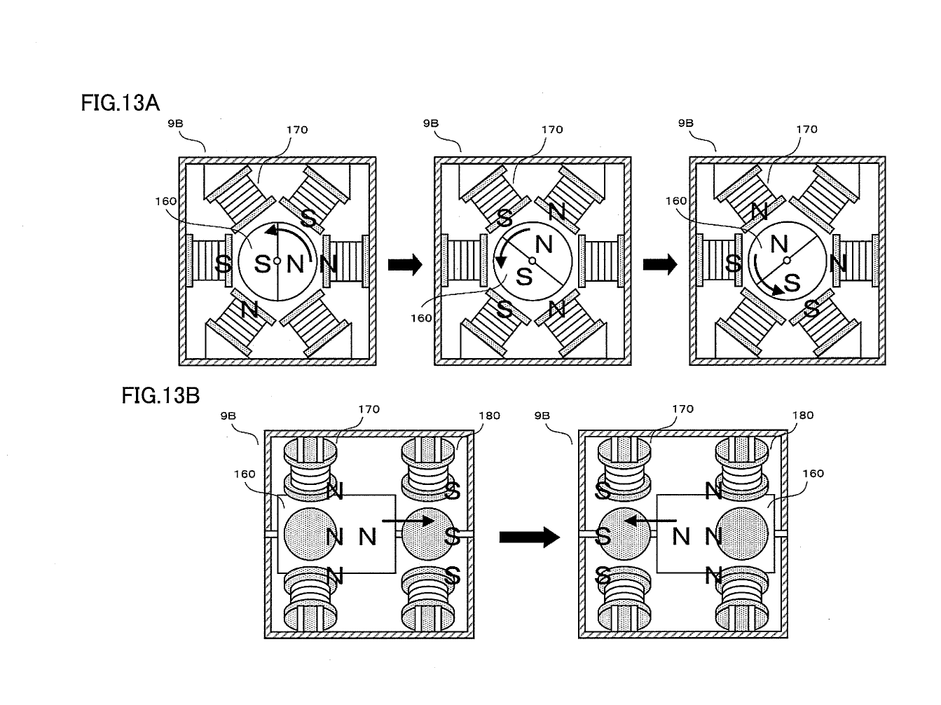

FIGS. 12A and 12B are a front perspective view and a side perspective view showing a configuration of vibrator 9B, respectively. FIG. 12C is a front view of portable telephone 1 having vibrator 9B disposed. FIG. 13A is a diagram showing rotation of a movable weight 160 and FIG. 13B is a diagram showing reciprocating motion of movable weight 160. An instance including vibrator 9B will be described with reference to FIGS. 12A to 12C and FIGS. 13A and 13B.

Vibrator 9B includes a case 150, movable weight 160, six first electromagnets 170, and six second electromagnets 180. Case 150 accommodates movable weight 160, six first electromagnets 170, and six second electromagnets 180.

Movable weight 160 is implemented by a permanent magnet having a cylindrical shape, and has an N magnetic pole region and an S magnetic pole region formed as being separated in a radial direction. Movable weight 160 can be held to be rotatable and movable in the left-right direction by means of a guide shaft 151 located in case 150.

Six first electromagnets 170 can be located to surround movable weight 160 on the left side in case 150. Each of first electromagnets 170 includes a core 171 and a coil 172 wound around core 171. By switching a direction of a current which flows through coil 172, a polarity of an end portion of core 171 which faces movable weight 160 can be switched. Six second electromagnets 180 can be located to surround movable weight 160 on the right side in case 150. Each of second electromagnets 180 includes a core 181 and a coil 182 wound around core 181. By switching a direction of a current which flows through coil 182, a polarity of an end portion of core 181 which faces movable weight 160 can be switched.

As shown in FIG. 13A, by successively switching a polarity of each of first electromagnets 170 and each of second electromagnets 180 in a circumferential direction, movable weight 160 can carry out rotational motion. As shown in FIG. 13B, by alternately switching between the N pole and the S pole such that a set of three first electromagnets 170 and a set of three second electromagnets 180 are reverse in polarity to each other, movable weight 160 can carry out reciprocating motion.

As shown in FIG. 12C, vibrator 9B can be located in the vicinity of center of gravity G in cabinet 2 such that movable weight 160 carries out reciprocating motion in the left-right direction of cabinet 2 and carries out rotational motion in the up-down direction. Portable telephone 1 can rotate in the left-right direction around axis of rotation R1, with moment M generated by reciprocating motion of movable weight 160 in the left-right direction, which has a difference in acceleration. Portable telephone 1 can rotate in the up-down direction around guide shaft 151, with moment M generated by rotational motion of movable weight 160.

A distance sensor may be located in portable telephone 1 in an embodiment above, the first modification, and the second modification. In this case, when control unit 11 determines that portable telephone 1 has fallen, a distance from the ground is measured with the distance sensor. When the distance is smaller than the lower limit height, control unit 11 does not control a position of portable telephone 1 with vibrator 9.

In position control processing in the first modification, when a position is such that a side surface of cabinet 2 will hit the ground, vibrator 9 is turned off so as to stop rotation of portable telephone 1. Depending on an impetus of rotation of portable telephone 1, however, a position may go beyond such a position that a side surface of cabinet 2 will hit the ground. In order to address this, such a configuration may be adopted that a position of portable telephone 1 is determined again after vibrator 9 is turned off and control unit 11 rotates portable telephone 1 in a reverse direction if portable telephone 1 has rotated to go beyond such a position that a side surface of cabinet 2 will hit the ground.

In an embodiment above, the first modification, and the second modification, when acceleration detector 21 detects an acceleration exceeding a drop threshold value, drop determination unit 31 determines that portable telephone 1 has fallen. Such a configuration may be adopted that a proximity sensor is used to detect whether or not a user holds portable telephone 1, and so long as portable telephone 1 is held, drop determination unit 31 determines that portable telephone 1 has not fallen in spite of detection of an acceleration exceeding the drop threshold value. Alternatively, such a configuration may be adopted that camera 8 is activated and when an acceleration exceeding the drop threshold value is detected and camera 8 shoots moving images impossible in normal use of portable telephone 1, drop determination unit 31 determines that portable telephone 1 has fallen. Further alternatively, such a configuration may be adopted that when an acceleration exceeding the drop threshold value is detected and change in position impossible in normal use (for example, rotation of portable telephone 1) is detected in portable telephone 1 by acceleration detector 21 or a geomagnetism sensor, drop determination unit 31 determines that portable telephone 1 has fallen.

Though an embodiment is applied to a portable telephone of a smartphone type, limitation thereto is not intended, and an embodiment may be applied to a portable telephone of other types such as a straight type, a foldable type, and a slidable type.

An embodiment is not limited to a portable telephone, but is applicable to various portable devices such as a personal digital assistant (PDA), a tablet PC, an electronic book terminal, a portable music player, a portable television, and a portable navigation system.

In addition, an embodiment is susceptible to various modifications as appropriate within the scope of technical concepts shown in the claims.

1. A portable device, comprising:
a housing;
a display located on a front surface side of the housing; and
a position change unit located in the housing and configured to change a position of the portable device which is falling,
the position change unit including
a movable unit,
a drive unit configured to drive the movable unit so as to carry out reciprocating motion in a direction in parallel to a front surface of the housing, and
at least one processor configured to control the drive unit, and
with reciprocating motion of the movable unit in which an acceleration in movement in one direction is higher than an acceleration in movement in the other direction, a moment which rotates the portable device in a first direction of rotation being generated around an axis in parallel to the front surface of the housing and perpendicular to a direction of the reciprocating motion.

2. The portable device according to claim 1, wherein
the at least one processor is configured to determine whether the portable device has fallen and to determine a position of the portable device while the portable device falls, and
the at least one processor is configured to rotate the portable device such that the portable device takes a prescribed position when the portable device falls.

3. The portable device according to claim 2, wherein
the at least one processor is configured to rotate the portable device so as to take a position with the front surface of the housing facing upward.

4. The portable device according to claim 2, wherein
the at least one processor is configured to rotate the portable device so as to take such a position that a side surface of the housing will hit a ground.

5. The portable device according to claim 2, further comprising a cover which covers a rear surface and upper, lower, left, and right side surfaces of the housing, wherein
a front edge of the cover protrudes forward from the front surface of the housing which is covered with the cover, and
the at least one processor is configured to rotate the portable device so as to take a position which deviates from a position with the front surface of the housing facing downward and extending horizontally.

6. The portable device according to claim 2, wherein
the at least one processor is configured to generate a moment which rotates the portable device in a second direction of rotation opposite to the first direction of rotation, with the reciprocating motion of the movable unit in which the acceleration in movement in the other direction is higher than the acceleration in movement in one direction, and to rotate the portable device in a direction of rotation of the first direction of rotation and the second direction of rotation, which is smaller in amount of rotation until the portable device takes the prescribed position.

7. The portable device according to claim 1, wherein
the movable unit includes a first movable unit and a second movable unit, and
the drive unit includes a first drive unit configured to drive the first movable unit so as to carry out reciprocating motion in a first direction in parallel to the front surface of the housing and a second drive unit configured to drive the second movable unit so as to carry out reciprocating motion in a second direction in parallel to the front surface of the housing and perpendicular to the first direction.

8. The portable device according to claim 1, wherein
the drive unit includes a first drive unit configured to drive the movable unit so as to carry out reciprocating motion in a first direction in parallel to the front surface of the housing and a second drive unit configured to drive the movable unit so as to carry out reciprocating motion in a second direction in parallel to the front surface of the housing and perpendicular to the first direction.

9. The portable device according to claim 1, wherein
the position change unit further includes a rotational drive unit which rotates the movable unit in an in-plane direction perpendicular to a direction of the reciprocating motion, and generates a moment which rotates the portable device in the perpendicular in-plane direction with rotational motion of the movable unit.

10. A position control method, comprising:
determining whether a portable device has fallen; and
generating a moment which rotates the portable device with reciprocating motion of a movable unit in a direction in parallel to a front surface of the portable device in which an acceleration in movement in one direction is higher than an acceleration in movement in the other direction while the portable device falls.
